(19) United States
(12) Patent Application Publication
(10) Pub. No.: US 2012/0181403 A1
(43) Pub. Date: Jul. 19, 2012

(54) Hanging Device

(76) Inventor: Tsung-Ying Lee, Tainan (TW)

(21) Appl. No.: 13/053,180

(22) Filed: Mar. 21, 2011

(30) Foreign Application Priority Data
Jan. 14, 2011 (TW) 100200899

(51) Int. Cl. F16B 45/00; F16M 13/00

(52) U.S. Cl. 248/225.21; 248/314

(57) ABSTRACT

A hanging device includes a holding set including a loop to hold an object and a fastening structure extending outward from one side of the loop. A supporting assembly includes at least one post, one end of which is axially coupled with the holding set by using at least one axial positioning structure, wherein the axial positioning structure is used to adjust and position the post.

### BACKGROUND OF THE PRESENT INVENTION

1. Field of Invention

The present invention relates to a hanging device that is capable of holding an object stably by using a loop of a holder.

2. Description of Related Arts

As shown in FIG. 1 and FIG. 2, a conventional hanging device 10 of a potted plant having a holder 101 to hold the potted plant 11, and the holder 101 includes a hook 102 fixed on one side thereof to hang the hanging device 10 on a wall.

However, the above-mentioned conventional hanging device still has the following disadvantages:

1. When the hanging device 10 is used to hold the potted plant 11 and is hanged on the wall, the potted plant 11 presses the holder 101, so that the outer sides of the hanging device 10 and the potted plant 11 become tilted downward, and the inner sides thereof abut against the wall, the potted plant 11 can not be held stably. When the wall is not flat, the potted plant 11 is held more obliquely. It makes the hanging device 10 and the potted plant 11 easy to fall.

2. The hanging device 10 is fixed without being adjusted its angle according to a shape of the wall or a type of the potted plant 11, only hanging the potted plant 11 obliquely.

3. The hanging device 10 is fixed without being stored, occupying space as storing the hanging device.

The present invention has arisen to mitigate and/or obviate the afore-described disadvantages.

### SUMMARY OF THE PRESENT INVENTION

The primary object of the present invention is to provide a hanging device that is capable of adjusting a contacting angle against a wall to hold an object stably by using a loop of a holder.

Further object of the present invention is to provide a hanging device that is capable of being adjusted based on various shapes of the wall to hold the object horizontally.

Another object of the present invention is to provide a hanging device that is capable of decreasing a store size of the hanging device so that the hanging device is portable and packed easily.

Accordingly, in order to accomplish the above objects, the present invention provides a hanging device comprising:

a holding set including a loop to hold an object and a fastening structure extending outward from one side of the loop;

a supporting assembly including at least one post, wherein the one end of the post is axially coupled with the holding set by using at least one axial positioning structure, and the axial positioning structure is used to adjust and position the post.

### BRIEF DESCRIPTION OF THE DRAWINGS

FIG. 1 is a plan view showing the operation of a conventional hanging device;

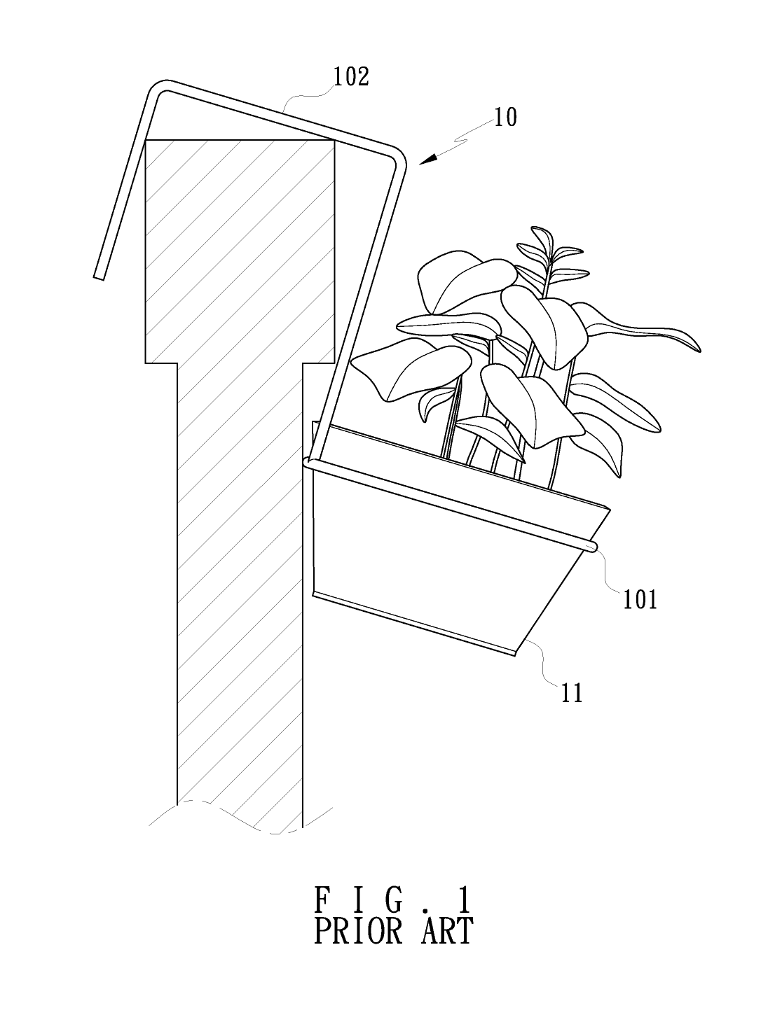

FIG. 2 is a perspective view showing the exploded components of a hanging device according to a first embodiment of the present;

FIG. 3 is a perspective view showing the assembly of the hanging device according to the first embodiment of the present;

FIG. 4 is a perspective view showing the operation of the hanging device according to the first embodiment of the present;

FIG. 5 is a cross sectional view showing the operation of the hanging device according to the first embodiment of the present;

FIG. 6 is another cross sectional view showing the operation of the hanging device according to the first embodiment of the present;

FIG. 7 is a perspective view showing the hanging device being stored according to the first embodiment of the present;

FIG. 8 is a perspective view showing the exploded components of a hanging device according to a second embodiment of the present

FIG. 9 is a perspective view showing the assembly of the hanging device according to the second embodiment of the present;

FIG. 10 is a perspective view showing the operation of the hanging device according to the second embodiment of the present;

FIG. 11 is a cross sectional view showing the operation of the hanging device according to the second embodiment of the present;

FIG. 12 is another cross sectional view showing the operation of the hanging device according to the second embodiment of the present;

FIG. 13 is a perspective view showing the hanging device being stored according to the second embodiment of the present;

FIG. 14 is a perspective view showing the exploded components of a hanging device according to a third embodiment of the present

FIG. 15 is a perspective view showing the assembly of the hanging device according to the third embodiment of the present;

FIG. 16 is a perspective view showing the operation of the hanging device according to the third embodiment of the present;

FIG. 17 is a cross sectional view showing the operation of the hanging device according to the third embodiment of the present;

FIG. 18 is another cross sectional view showing the operation of the hanging device according to the third embodiment of the present;

FIG. 19 is a perspective view showing the exploded components of a fastening structure of a hanging device according to a fourth embodiment of the present

FIG. 20 is a perspective view showing the assembly of the fastening structure of the hanging device according to the fourth embodiment of the present.

### DETAILED DESCRIPTION OF THE PREFERRED EMBODIMENT

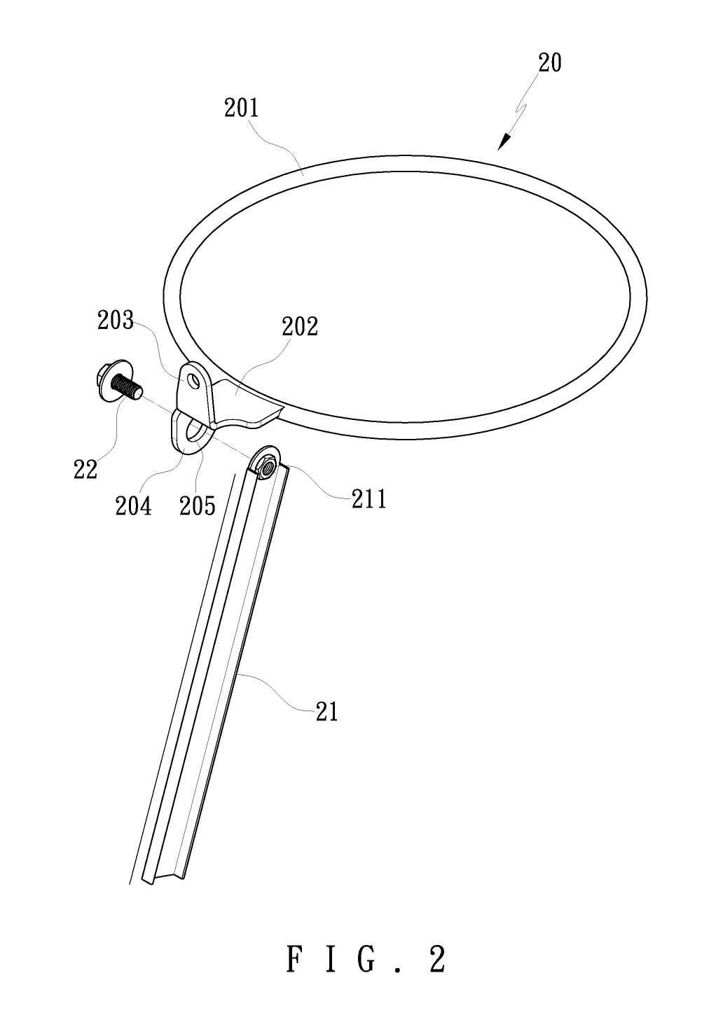

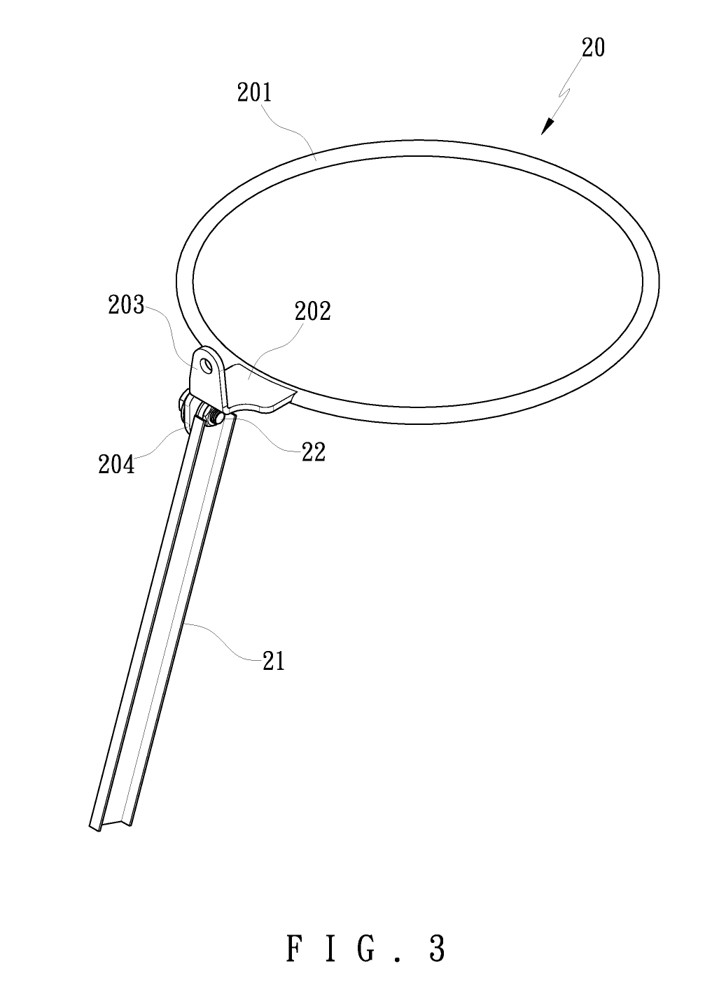

Referring to FIGS. 2 and 3, a hanging device in accordance with a first embodiment of the present invention comprises a holding set 20 and a supporting assembly. The holder 20 includes an annular loop 201 for holding an object and a connector 202 extending outward from one side of the loop 201. The connector 202 has a fastening structure to hang the holder 20 on a wall. In this embodiment, the fastening structure includes a positioning piece 203 extending upward from the holder 202 and having a hole which is arranged to match with a hook. The holding set 20 also includes a coupling portion 204 extending downward from the holder 202 and having an aperture 205 which is arranged to connect with the supporting assembly. In this embodiment, the supporting assembly includes a post 21. One end of the post 21 is axially coupled with the coupling portion 204 of the holding set 20 by using an axial positioning structure, so that the post 21 is axially positioned at a first suitable angle so as to further abut against the wall at a first contacting angle, wherein the axial positioning structure includes a first bolt 22 which is inserted into the aperture 205 of the holding set 20, and a first screw bore 211 which is disposed on one end of the post 21 to screw with the first bolt 22, such that the first bolt 22 is released to rotate the post 21 at a second suitable angle, and another end of the post 21 is biased against the wall below the holding set 20, thereafter the first bolt 22 is locked.

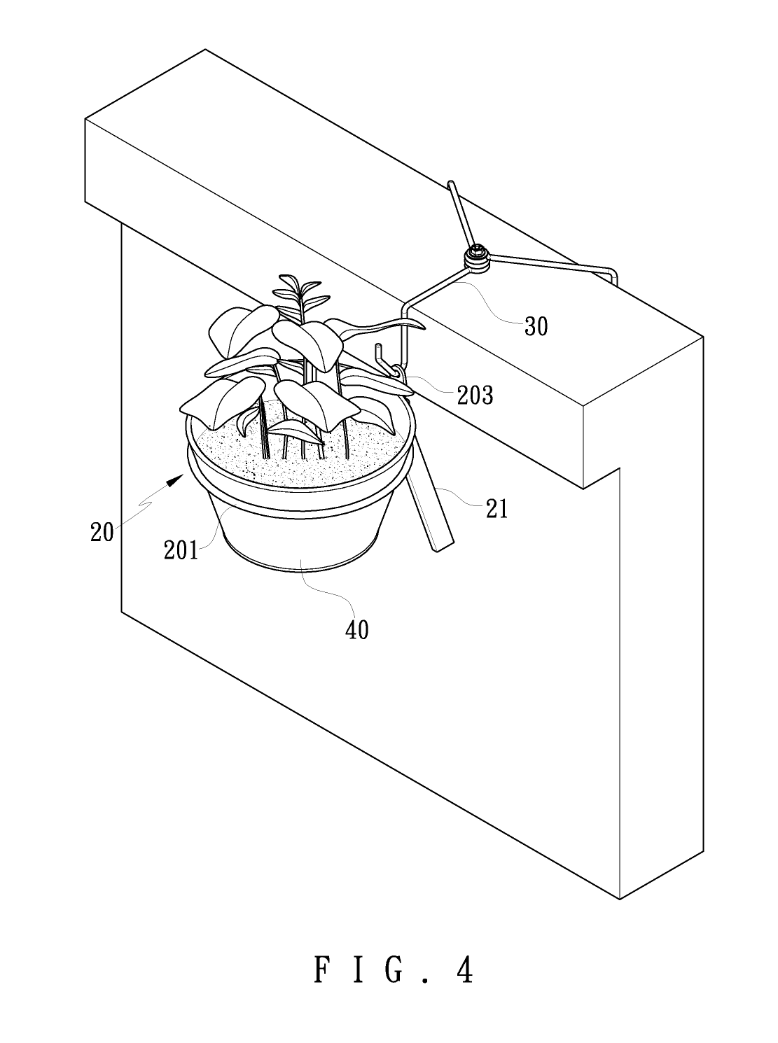

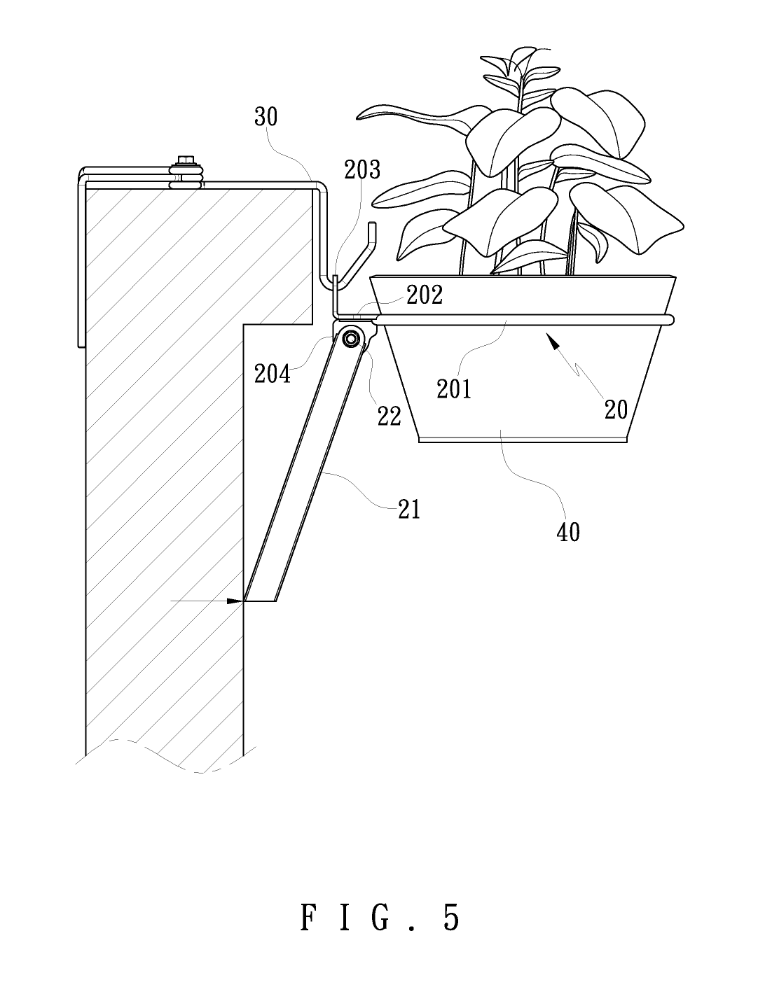

Referring to FIGS. 4 and 5, in operation, the hook 30 is used to hook the hanging device of the first embodiment of the present invention on the wall, wherein the hook 30 is fixed on the wall, and then the holding set 20 is hanged on the hook 30 by ways of the hole of the positioning piece 203. The post 21 of the supporting assembly is rotated axially toward one side of the wall to adjust its first contacting angle, such that the another end of the post 21 is biased against the wall below the holding set 20 at the first suitable angle so that the holding set 20 is fixed horizontally. Thereafter, the post 21 is positioned by means of the first bolt 22, hence the loop 201 of the holding set 20 is capable of holding the object 40 (such as a potted plant). When the loop 201 of the holding set 20 is pressed downward by the object 40, a horizontal counterforce generates between the post 21 of the supporting assembly and the wall to balance a downward gravity of the object 40, such that the holding set 20 is capable of holding the object 40 stably. In addition, a second contacting angle of the holding set 20 is capable of being adjusted based on various shapes of the wall to hold the object 40 horizontally.

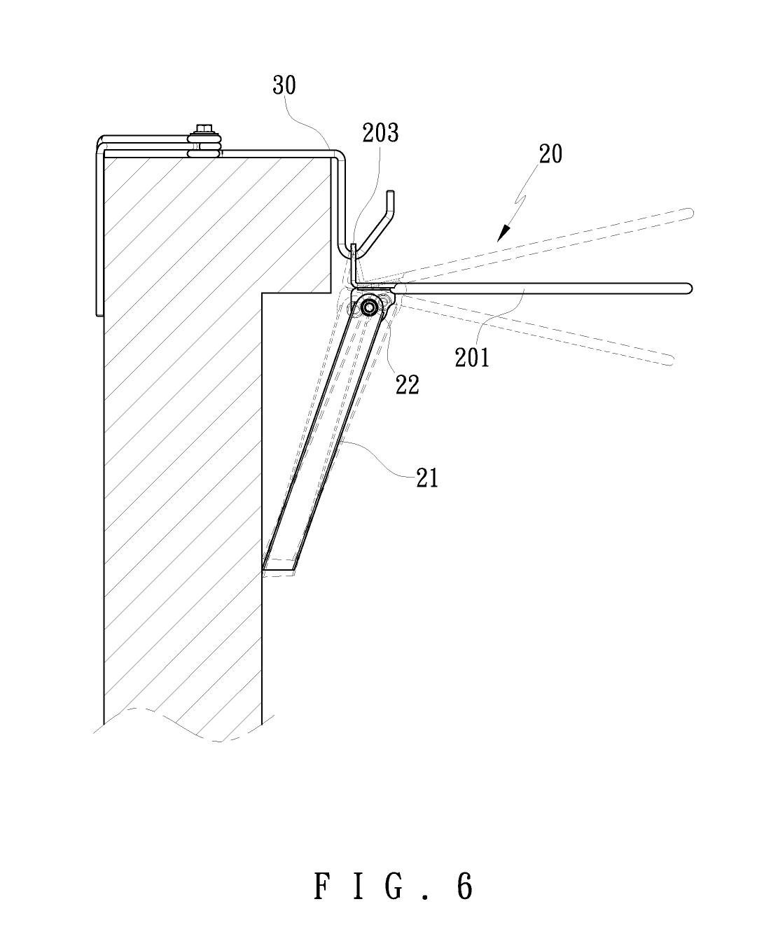

As shown in FIG. 6, the holding set 20 is able to adjust the first contacting angle of the post 21 against the wall by using the axial positioning structure based on user requirement. The loop 201 of the holding set 20 moves upward or downward to hold the object at different angles.

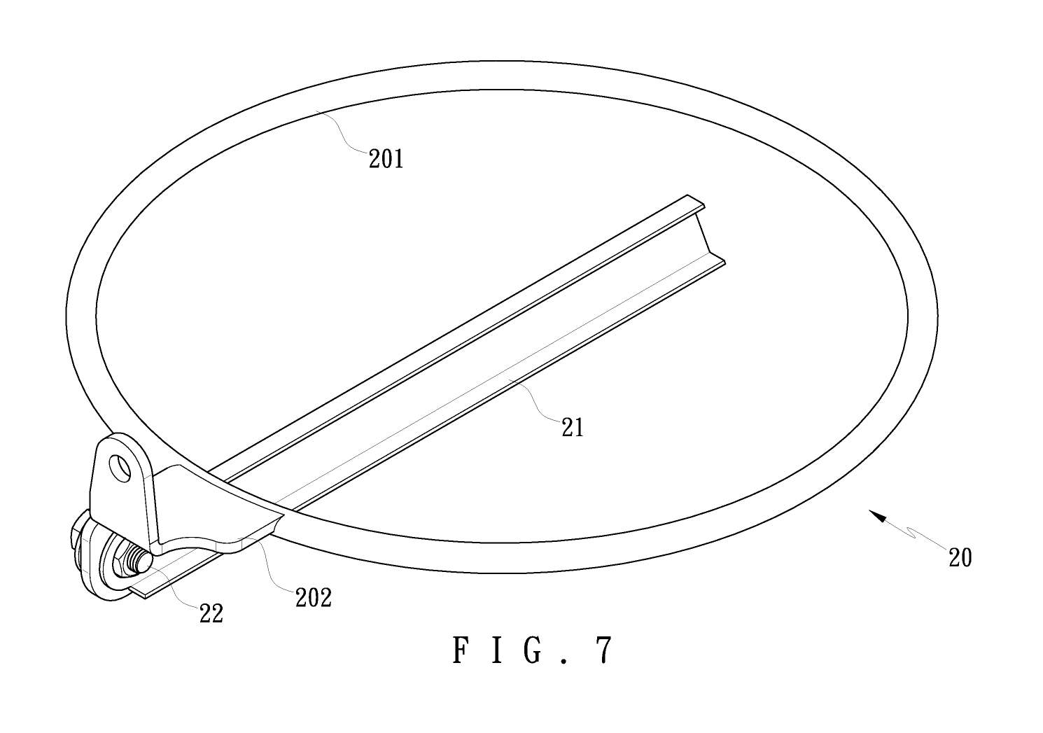

As illustrated in FIG. 7, as storing the hanging device of the first embodiment of the present invention, the post 21 of the supporting assembly is rotated axially to be retracted with the holding set 20, thus decreasing a store size of the hanging device so that the hanging device is portable and packed easily.

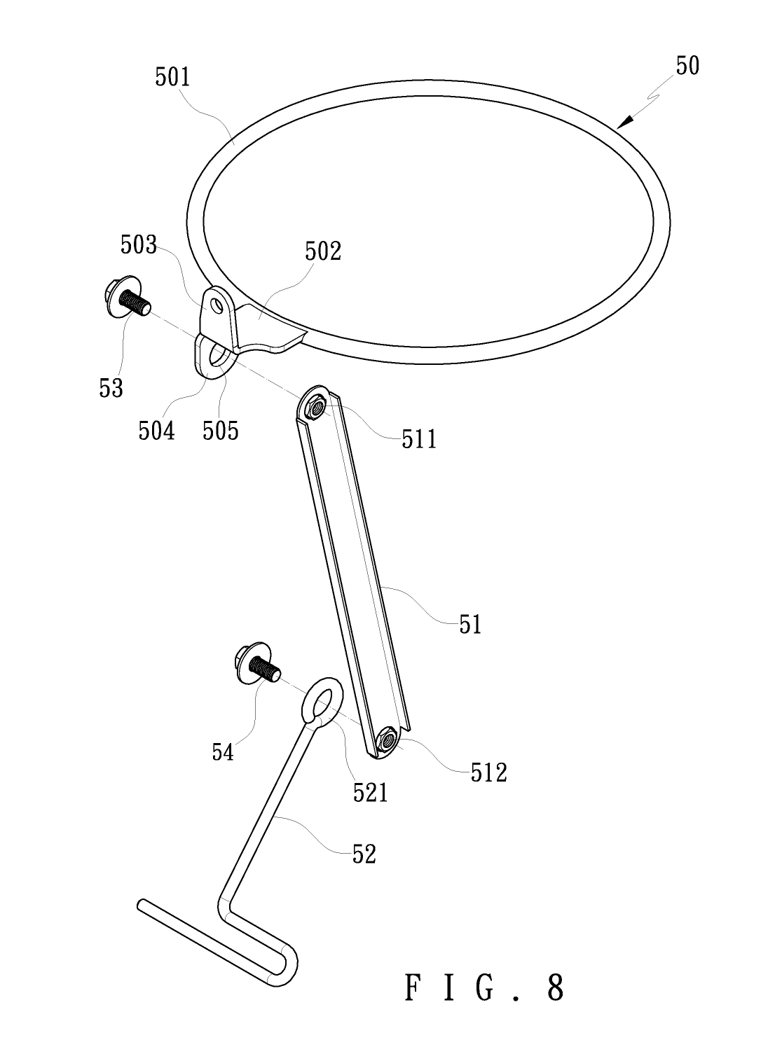

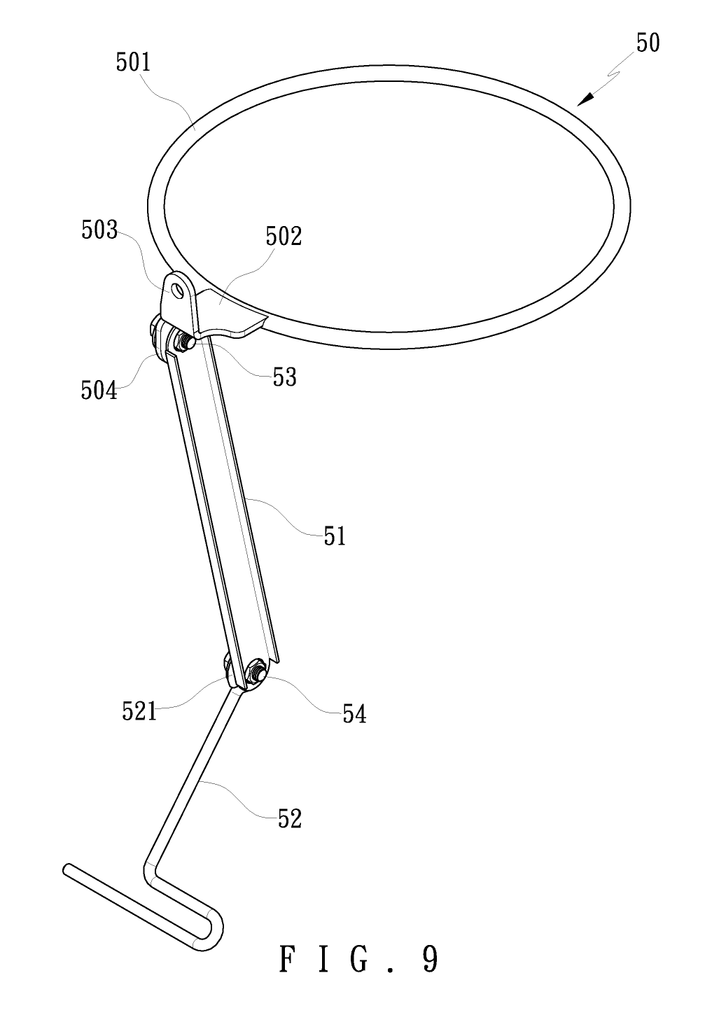

With reference to FIGS. 8 and 9, a hanging device according to a second embodiment of the present invention comprises a holding set 50 and a supporting assembly, the holder set 50 having an annular loop 501 to hold an object and a connector 502 extending outward from one side of the loop 501. The connector 502 has a fastening structure to hang the holder 50 on a wall. In this embodiment, the fastening structure includes a positioning piece 503 extending upward from the holder 502 and having a hole which is arranged to match with a hook. The holding set 50 also includes a coupling portion 504 extending downward from the holder 502 and having an aperture 505 which is arranged to connect with the supporting assembly. In this embodiment, the supporting assembly includes a first post 51 and a second post 52, wherein one end of the first post 501 is axially coupled with the coupling portion 504 of the holding set 50 by using a first axial positioning structure, so that the first post 51 is axially positioned at a first suitable angle. The first axial positioning structure includes a first bolt 53 inserted into the aperture 505 of the holding set 50, and the first post 51 includes a first screw bore 511 disposed on the one end thereof to screw with the first bolt 53, such that a first contacting angle of the first post 51 is adjusted. Another end of the first post 51 is connected with a Tee end of the second post 52 by ways of a second axial positioning structure, and the second post 52 is axially rotated to be further positioned at a second suitable angle to further adjust a second contacting angle of the second post 52 against the wall; wherein the second axial positioning structure includes a circular connecting portion 521 formed on one end of the second post 52 to insert a second bolt 54, and the first post 51 includes a second screw bore 512 fixed on the another end thereof to screw with the second bolt 54, thus adjusting the second contacting angle of the second post 52.

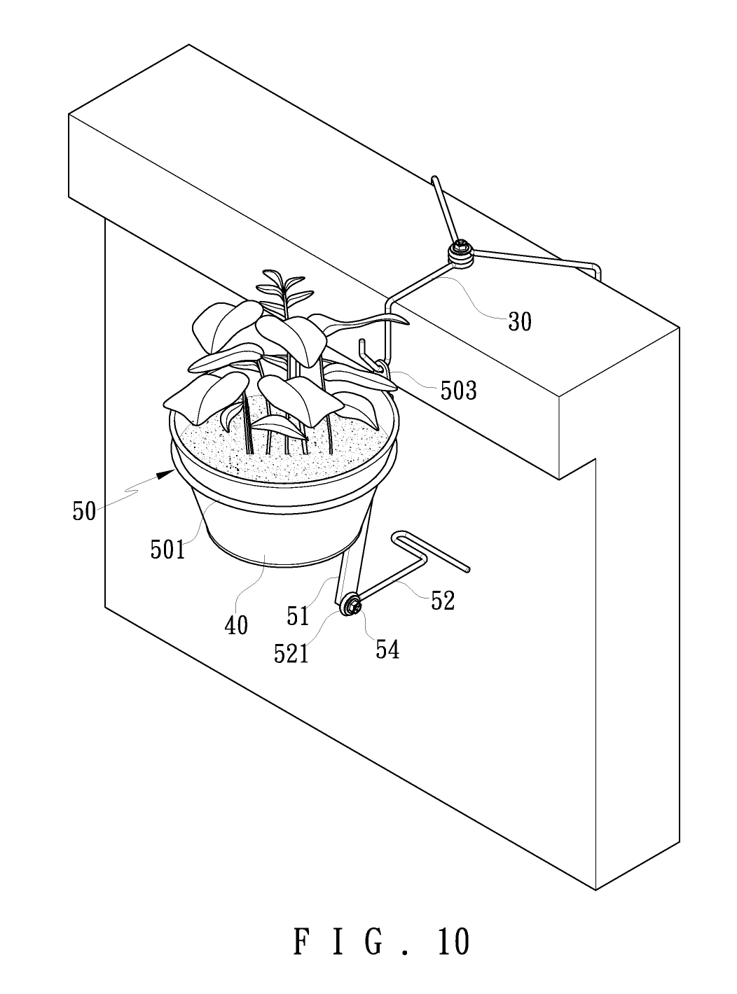

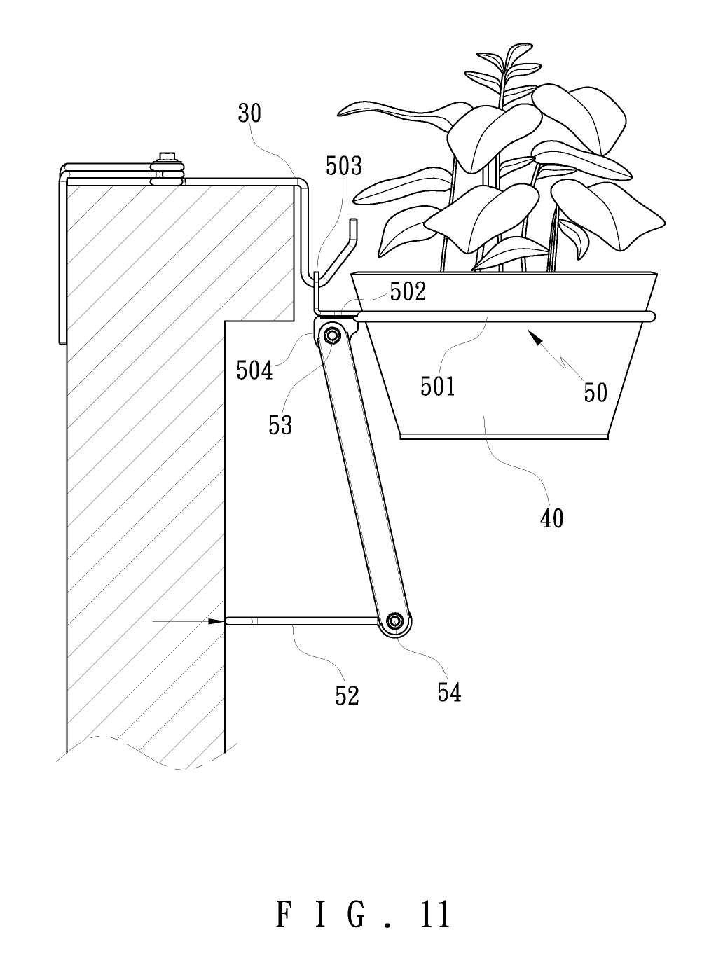

Referring to FIGS. 10 and 11, in operation, the hook 30 is used to hook the hanging device of the second embodiment of the present invention on the wall, wherein the hook 30 is fixed on the wall, and then the holding set 50 is hanged on the hook 30 by ways of the hole of the positioning piece 503. The first post 51 of the supporting assembly is rotated axially toward the first suitable angle and is fixed by the first bolt 53. The second post 52 is axially rotated toward the second suitable angle, and the other end of the second post 52 is biased against the wall below the holding set 50 at a third suitable angle, thereafter the second post 52 is locked by the second bolt 54, thereby holding the object 40 by means of the loop 501 of the holding set 50. When the loop 501 of the holding set 50 is pressed downward by the object 40, a horizontal counterforce generates among the first post 51, the second post 52, and the wall to balance a downward gravity of the object 40, such that the holding set 50 is capable of holding the object 40 stably. In addition, a third contacting angle of the holding set 50 is capable of being adjusted based on various shapes of the wall to hold the object 40 horizontally.

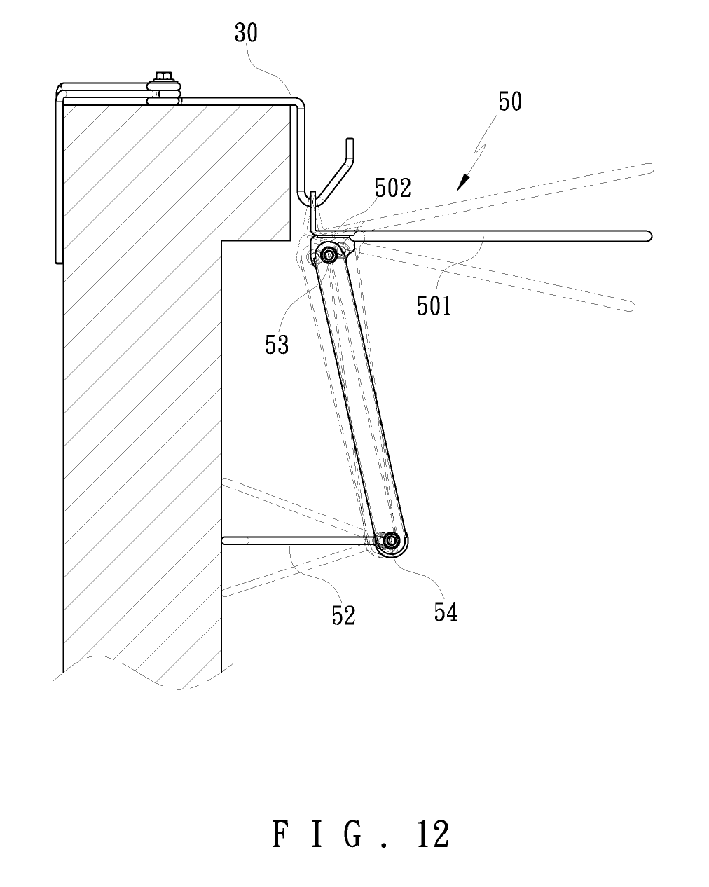

As shown in FIG. 12, the holding set 50 is able to adjust the first, the second, and the third contacting angles of the first post 51, the second post 52, and the wall by using the first and the second axial positioning structures respectively based on requirement. The loop 501 of the holding set 50 moves upward or downward to hold the object at different angles.

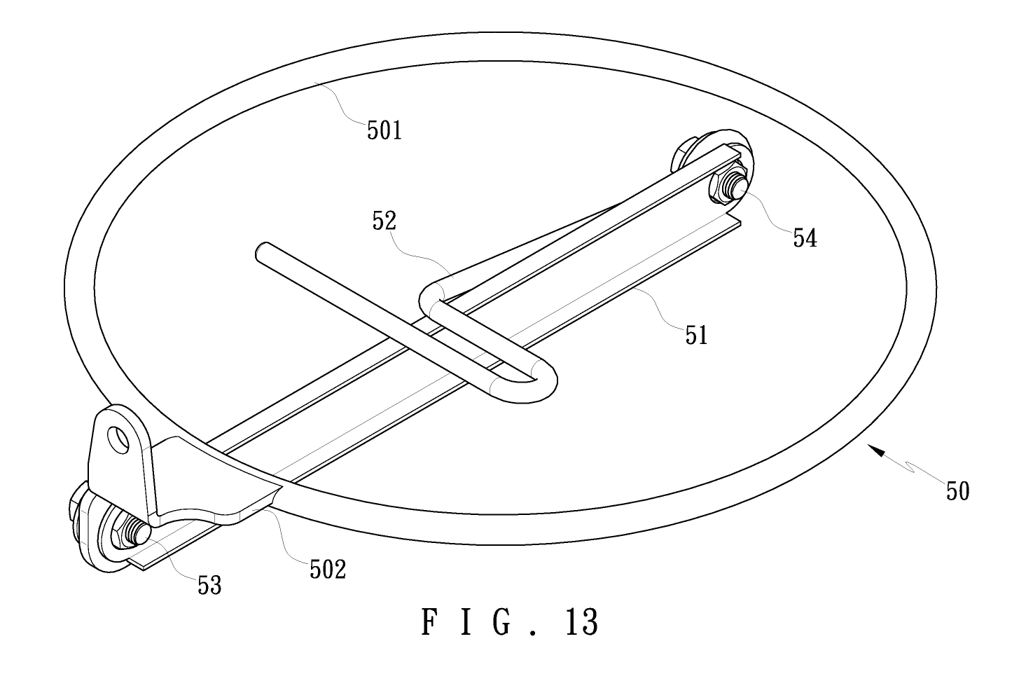

As illustrated in FIG. 13, as storing the hanging device of the second embodiment of the second embodiment of the present invention, the first and the second posts 51, 52 of the supporting assembly are rotated axially to be retracted with the holding set 50, thus decreasing a store size of the hanging device so that the hanging device is portable and packed easily.

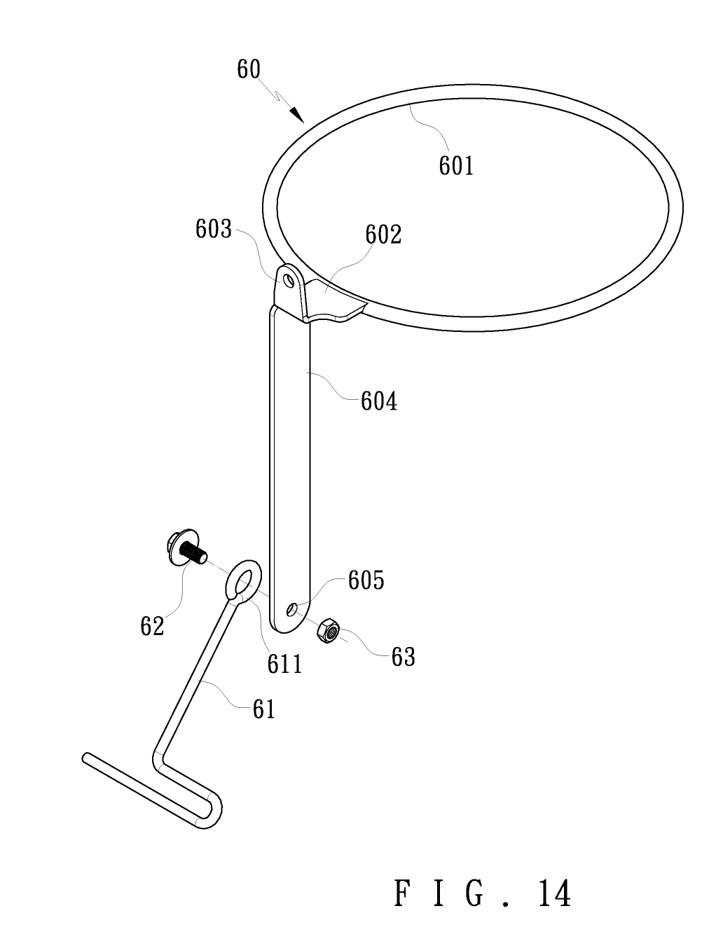

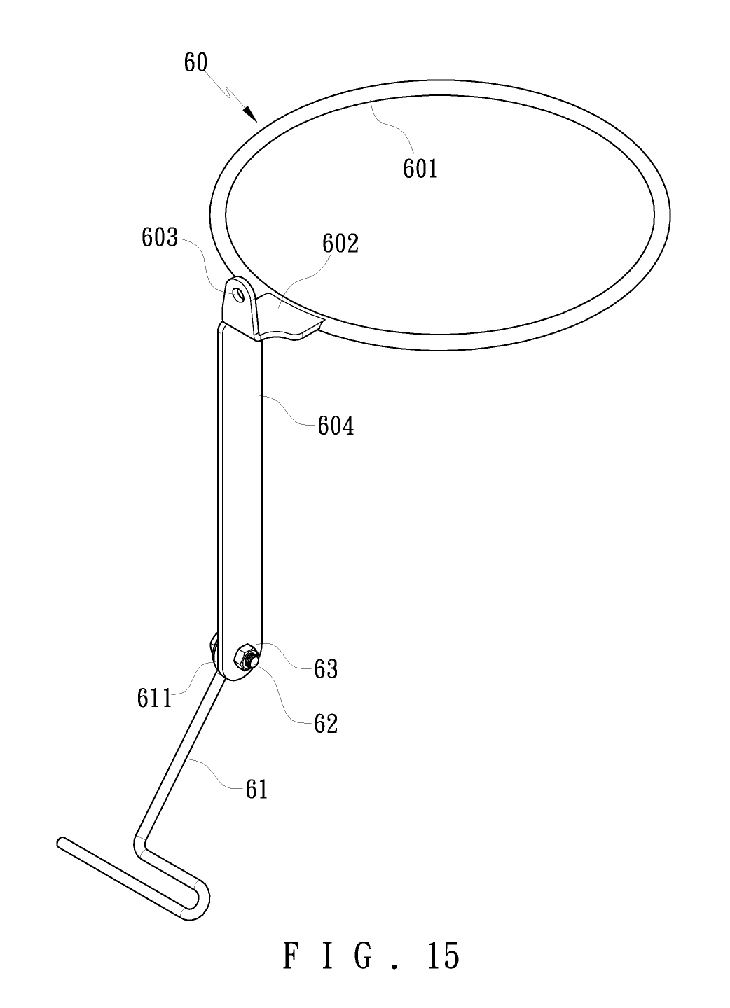

Referring to FIGS. 14 and 15, a hanging device in accordance with a third embodiment of the present invention comprises a holding set 60 and a supporting assembly. The holder 60 including an annular loop 601 to hold an object and a connector 602 extending outward from one side of the loop 601. The connector 602 has a fastening structure to hang the holder 60 on a wall. In this embodiment, the fastening structure includes a positioning piece 603 extending upward from the holder 602 and having a hole which is arranged to match with a hook. The holding set 60 also includes a rod 604 extending downward from the holder 602 and having an opening 605 which is arranged on a bottom end of the rod 604 to connect with the supporting assembly. In this embodiment, the supporting assembly includes a Tee post 61. One end of the Tee post 61 is axially coupled with the bottom end of the rod 604 of the holding set 60 by using an axial positioning structure, so that the post 61 is axially positioned at a first suitable angle so as to further abut against the wall at a first contacting angle, wherein the axial positioning structure includes a first bolt 62 inserted into the opening 605 of the holding set 60, and the post 61 includes a circular connecting portion 611 formed on one end thereof to insert the first bolt 62. The first bolt 62 is screwed with a nut 63, thus adjusting the first contacting angle of the post 61.

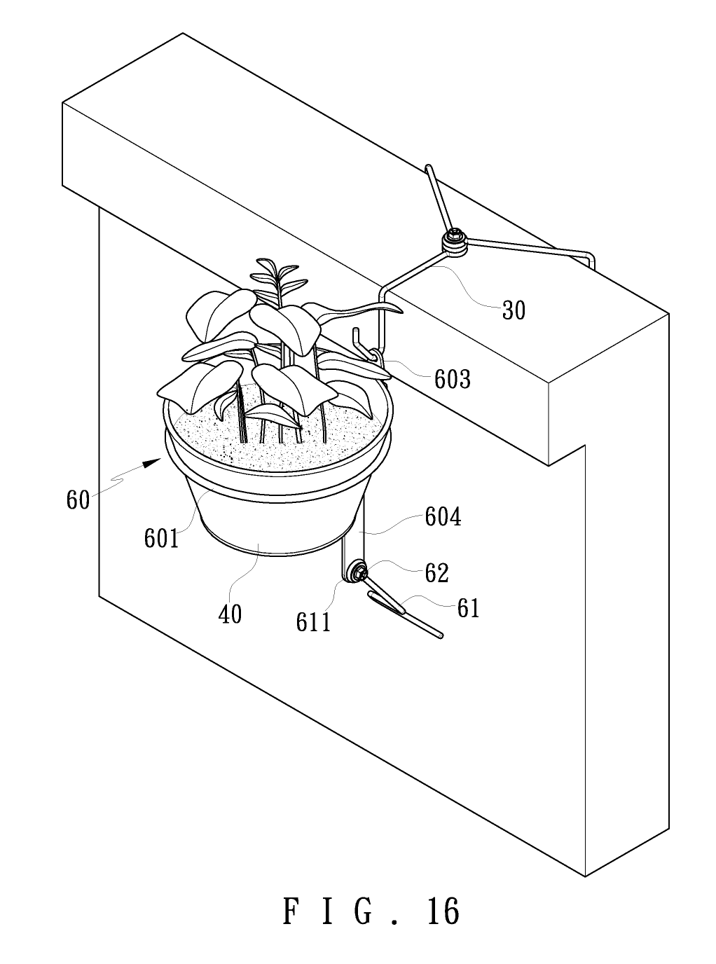

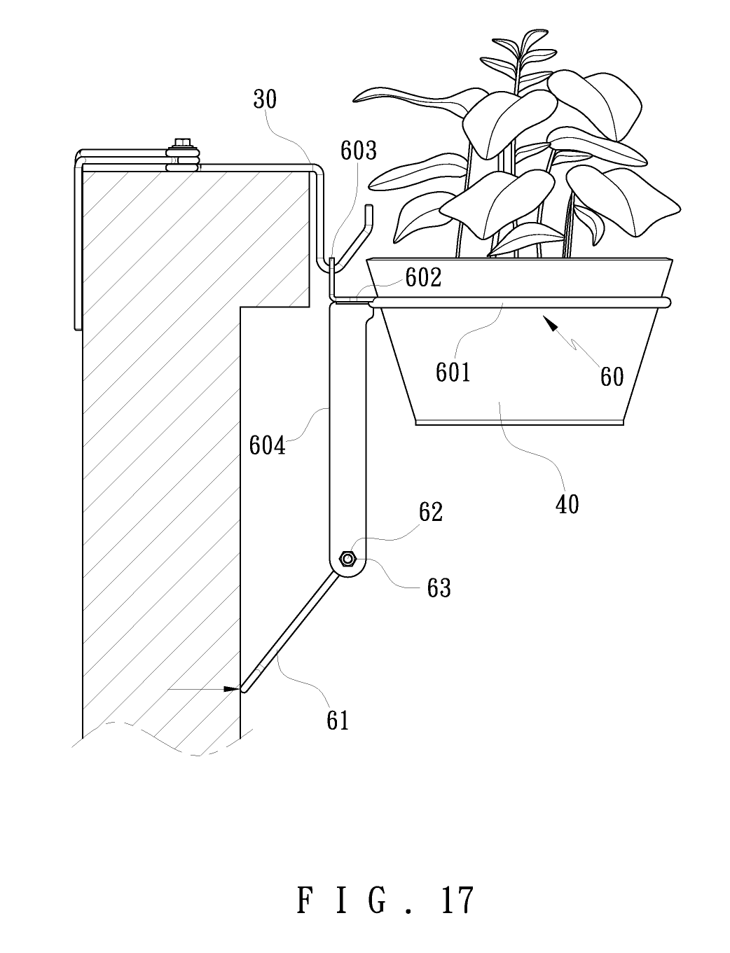

Referring to FIGS. 16 and 17, in operation, the hook 30 is used to hook the hanging device of the third embodiment of the present invention on the wall, wherein the hook 30 is fixed on the wall, and then the holding set 60 is hanged on the hook 30 by ways of the hole of the positioning piece 603. The post 61 of the supporting assembly is rotated axially toward one side of the wall to adjust its first contacting angle, such that another end of the post 61 is biased against the wall below the holding set 60 at the first suitable angle, and the first contacting angle of the post 61 is adjusted so that the holding set 60 is fixed horizontally, thereafter the post 61 is fixed by the first bolt 62, thus holding the object 40 by means of the holding set 60. When the loop 601 of the holding set 60 is pressed downward by the object 40, a horizontal counterforce generates between the post 61 and the wall to balance a downward gravity of the object 40, such that the holding set 60 is capable of holding the object 40 stably. In addition, a second contacting angle of the holding set 60 is capable of being adjusted based on various shapes of the wall to hold the object 40 horizontally.

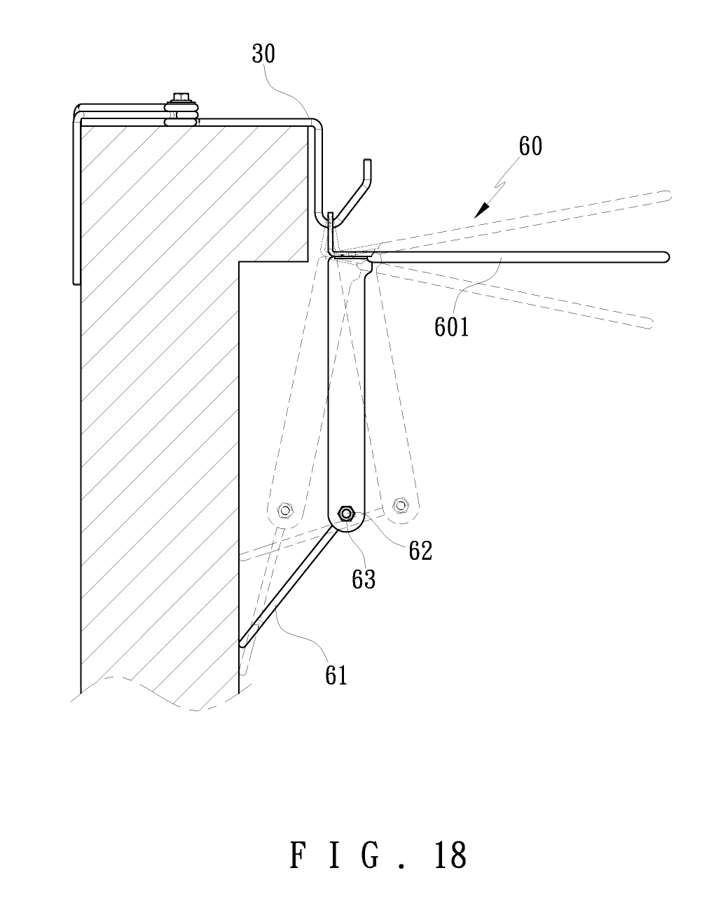

As shown in FIG. 18, the holding set 60 is able to adjust the first contacting angle of the post 61 against the wall by using the axial positioning structure based on requirement. The loop 601 of the holding set 60 moves upward or downward to hold the object at different angles.

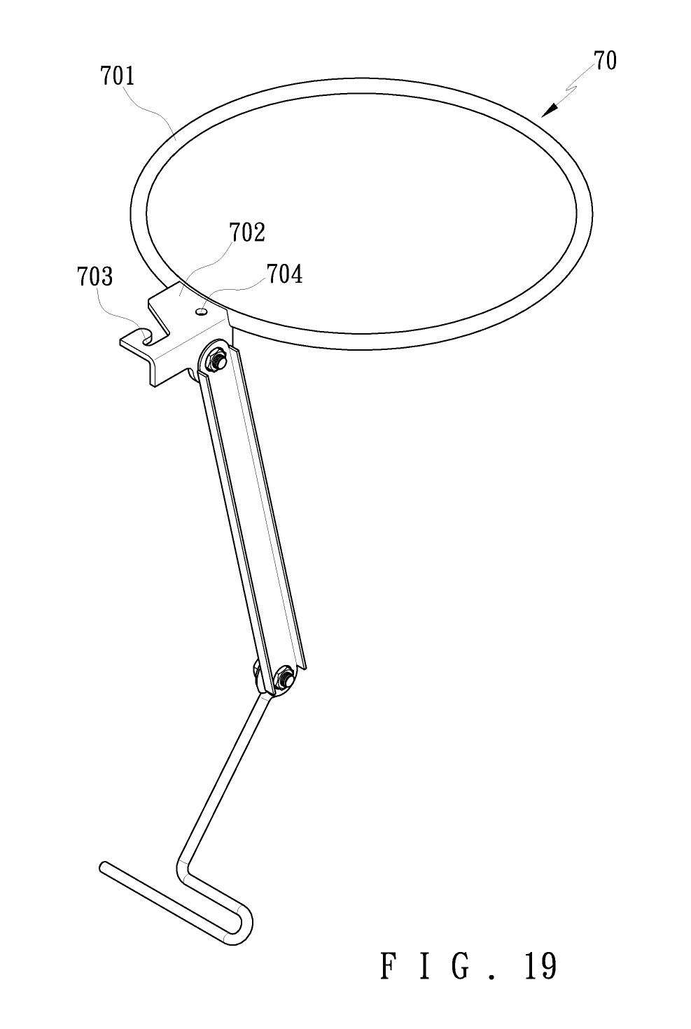

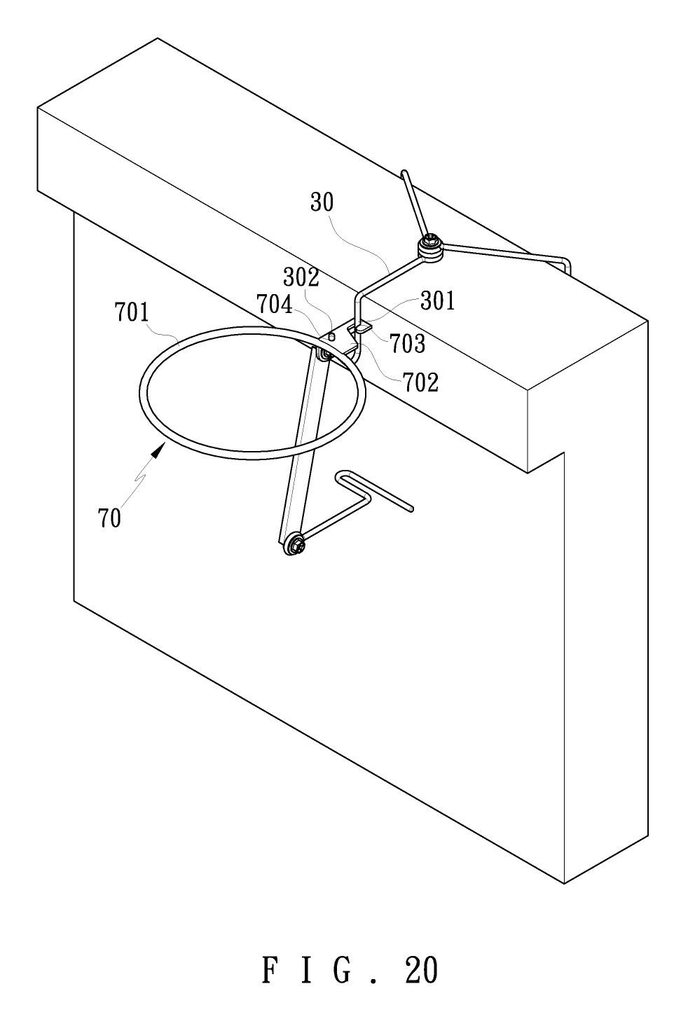

Furthermore, the connector of the holder includes the fastening structure to hang the holder on a wall, wherein the fastening structure is capable of being directly formed in a hook shape on the connector or formed in another shape to match with the hook. As shown in FIGS. 19-20, a hanging device in accordance with a fourth embodiment of the present invention comprises a holding set 70 including an annular loop 701 to hold an object and a connector 702 extending outward from one side of the loop 701 and having the fastening structure to hang the holding set 70 by cooperating with a hook 30; wherein the fastening structure includes a limiting slot 703 formed on the connector 702 to retain an extension 301 of the hook 30 and a recesses 704 arranged on the connector 702 in response to a head end 302 of the hook 30 so as to further insert the head 302. The holding set 70 includes a supporting assembly disposed on a bottom end thereof to abut against the wall, thereby holding the object horizontally.

The invention is not limited to the above embodiment but various modifications thereof may be made. It will be understood by those skilled in the art that various changes in form and detail may made without departing from the scope and spirit of the present invention.

What is claimed is:

1. A hanging device comprising:
a holding set including a loop for holding an object and a fastening structure extending outward from one side of said loop;
a supporting assembly including at least one post, wherein one end of said post is axially coupled with said holding set by using at least one axial positioning structure, wherein said axial positioning structure is used to adjust and position said post.

2. The hanging device, as recited in claim 1, wherein said loop is annular.

3. The hanging device, as recited in claim 1, wherein said fastening structure further includes a positioning piece extending upward from the holder and having a hole arranged to match with a hook.

4. The hanging device, as recited in claim 1, wherein said fastening structure further includes a limiting slot formed on a connector to retain an extension of a hook and a recess arranged on said connector in response to a head end of said hook so as to further insert the head.

5. The hanging device, as recited in claim 1, wherein said holding set also includes a coupling portion extending downward from the holder and having an aperture to connect with said post of said supporting assembly.

6. The hanging device, as recited in claim 5, wherein said axial positioning structure further includes a first bolt inserted into said aperture of said holding set, and a first screw bore which is disposed on one end of said post to screw with said first bolt.

7. The hanging device, as recited in claim 1, wherein said supporting assembly includes a first post and a second post, wherein one end of said first post is axially coupled with said holding set by using a first axial positioning structure, wherein another end of said first post is connected with said second post by ways of a second axial positioning structure.

8. The hanging device, as recited in claim 7, wherein said first axial positioning structure includes a first bolt inserted into said aperture of said coupling portion of said holding set, wherein said first post includes a first screw bore disposed on the one end thereof to screw with said first bolt.

9. The hanging device, as recited in claim 7, wherein said second axial positioning structure further includes a circular connecting portion formed on one end of said second post to insert a second bolt, wherein said first post includes a second screw bore fixed on the another end thereof to screw with said second bolt.

10. The hanging device, as recited in claim 1, wherein said holding set also includes a rod extending downward from said holder and having an opening arranged on a bottom end of said rod to connect with said supporting assembly.
